(19) United States
(12) Patent Application Publication
(10) Pub. No.: US 2024/0359508 A1
(43) Pub. Date: Oct. 31, 2024

(54) Adaptive Sensor Data Acquisition

(71) Applicant: ZEBRA TECHNOLOGIES CORPORATION, Lincolnshire, IL (US)

(72) Inventors: Raghavendra Tenkasi Shankar, Holbrook, NY (US); David S. Koch, East Islip, NY (US)

(21) Appl. No.: 18/140,727

(22) Filed: Apr. 28, 2023

(51) Int. Cl. B60C 11/24; G01M 17/02

(52) U.S. Cl. CPC B60C 11/246; G01M 17/027

(57) ABSTRACT

A method includes: monitoring sensor data including one or more representations of a treaded surface captured by a device; detecting, based on the sensor data, that the device has traversed a boundary of the treaded surface; in response to detecting that the device has traversed the boundary, determining a scan trigger point within the one or more representations; and generating a profile of the treaded surface from the one or more representations based on the scan trigger point.

### BACKGROUND

Tire wear, which may dictate the need for replacement of a tire, may be assessed by measuring the depth of tire treads. A worn tire exhibiting shallower treads may require replacement. Tire tread depth can be measured manually with a tread depth gauge, but such measurements may be prone to measurement errors. Imaging-based tread depth measurement devices may provide increased measurement accuracy, but may be suitable for a limited range of operators and/or tire types.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a computing device for capturing depth scan data from a tire.

FIG. 2 is a schematic of the computing device of FIG. 1 during capture of the depth scan data.

FIG. 3 is a diagram illustrating depth scan data captured by the device of FIG. 1.

FIG. 4 is a block diagram of certain internal hardware components of the device of FIG. 1.

FIG. 5 is a flowchart of a method of adaptive sensor data acquisition.

FIG. 6 is a diagram illustrating an example performance of blocks 510 and 515 of the method of FIG. 5.

FIG. 7 is a diagram illustrating an example performance of blocks 525 and 535 of the method of FIG. 5.

FIG. 8 is a diagram illustrating a change in orientation of the device of FIG. 1 during a scan operation.

FIG. 9 is a diagram illustrating an example performance of blocks 530 and 535 of the method of FIG. 5, following the orientation change illustrated in FIG. 8.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method including: monitoring sensor data including one or more representations of a treaded surface captured by a device; detecting, based on the sensor data, that the device has traversed a boundary of the treaded surface; in response to detecting that the device has traversed the boundary, determining a scan trigger point within the one or more representations; and generating a profile of the treaded surface from the one or more representations based on the scan trigger point.

Additional examples disclosed herein are directed to a computing device, comprising: an emitter; a sensor; and a processor configured to: monitor sensor data including one or more representations of a treaded surface captured by the sensor; detect, based on the sensor data, that the device has traversed a boundary of the treaded surface; in response to detecting that the device has traversed the boundary, determine a scan trigger point within the one or more representations; and generate a profile of the treaded surface from the one or more representations based on the scan trigger point.

Tire tread depth can be measured with a tire tread depth gauge, which generally includes a plunger or other movable rod, post, or the like, extending from a gauge housing. The housing supports a sensor configured to indicate the extent to which the plunger is currently extended from the housing (e.g., into a tread of a tire, to contact the bottom of the tread). Assessing tread wear of a tire may involve collecting several distinct measurements from several different treads with such a gauge, which can be time-consuming.

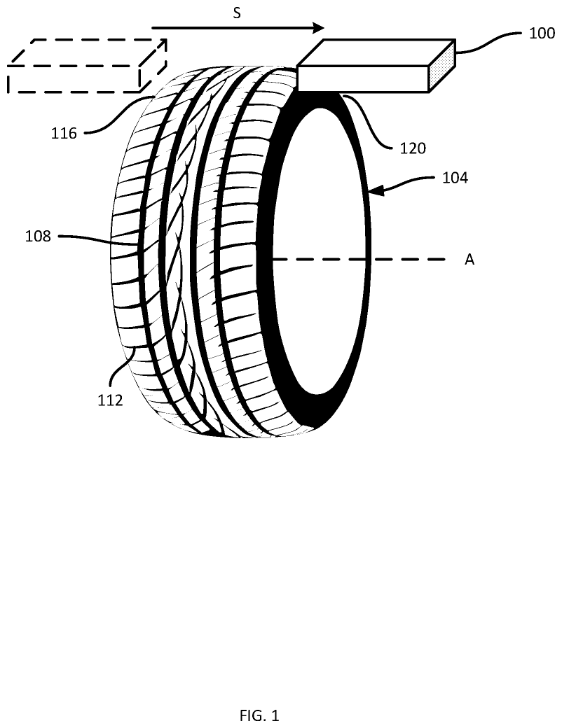

Image-based tread depth measurement can facilitate the collection of tread depth measurements, e.g., across a plurality of tire treads, more quickly than manual measurement of each tread with a gauge as set out above. FIG. 1 illustrates an example computing device 100 for collecting image-based depth measurements, e.g., from a tire 104. The device 100 can also be used to collect depth measurements for objects other than the tire 104.

The tire 104 may be mounted on a vehicle, such as an automobile, delivery van, trailer, or the like, but is shown in isolation. The device 100 is configured to generate depth measurements for a plurality of treads of the tire 104. The depth measurements generated by the device 100 are also referred to as a tire tread profile, or simply a profile, of the treaded surface of the tire 104. The treads of the tire 104 can include major treads 108, and minor treads 112. The major treads 108, of which the tire 104 as illustrated has four, typically extend continuously around the circumference of the tire 104. The minor treads 112 do not necessarily extend continuously around the circumference of the tire 104. For example, the minor treads 112 can be arranged at various angles relative to the major treads 112, and have various lengths smaller than the circumference of the tire 104. The minor treads 112 can also have smaller tread depths than the major treads 108.

In the present example, the device 100 is a mobile computing device, such as a mobile computer (e.g., a handheld computer) configured to generate the depth measurements by traversing (e.g., via manipulation by an operator, not shown) the tire 104 or other object to be scanned in a scan direction S, from an initial position shown in dashed lines to a final position shown in solid lines. In the present example, the scan direction S is parallel to an axis A of the tire. That is, the scan direction S, in this example, is perpendicular to the major treads 108. As will be apparent, to scan the full width of the tire 104, the device 100 traverses a leading boundary 116 of the tire 104, and a trailing boundary 120 of the tire 104. The leading and trailing boundaries 116 and 120 can correspond, for example, to the sidewalls of the tire 104, and define boundaries of the treaded surface to be measured.

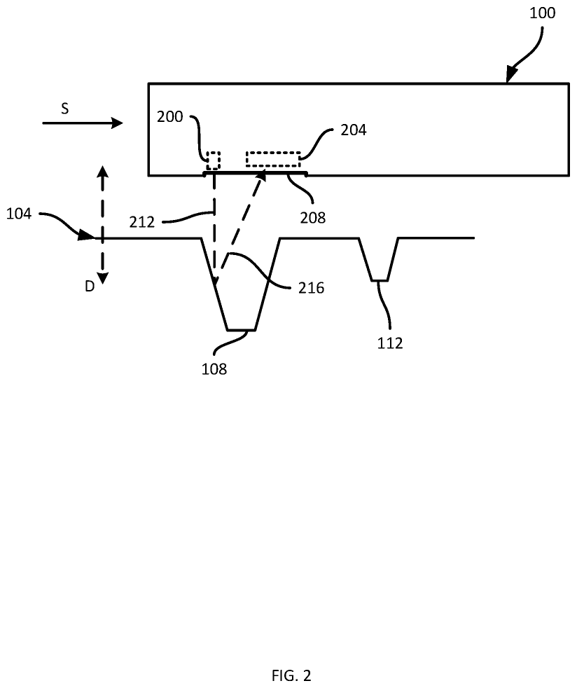

As the device 100 traverses the tire 104 in the scan direction S, the device 100 can collect depth measurements across the treaded surface of the tire 104, e.g., by emitting a beam of light and capturing reflections of the beam of light from the tire 104, as discussed below in connection with FIG. 2.

FIG. 2 illustrates the device 100 and the treaded surface of the tire 104 from the side, as the device 100 traverses the treaded surface in the scan direction S. The device 100 includes a light emitter 200 (e.g., a laser emitter such as a laser diode) and an image sensor 204, such as a charge-coupled device (CCD), complementary metal oxide semiconductor (CMOS) or the like, as well as associated optics (e.g. lenses, filters or the like). The image sensor 204 can be implemented, in some examples, as a one-dimensional array, e.g., a line of pixels. In other examples, the sensor 204 can include a depth sensor such as a time-of-flight (ToF) sensor, an ultrasonic sensor, or the like. The emitter 200 and the image sensor 204 are disposed within a housing of the device 100, and the device 100 further includes a transparent scan window 208 permitting the exit of light emitted by the emitter 200, and the entry of light reflected from the tire 104 for capture by the image sensor 204.

The device 100, and specifically the emitter 200, thus emits a beam 212 of light (e.g., a laser beam) through the window 208. The beam 212 impacts the treaded surface of the tire 104, and a portion of the emitted light is reflected back towards the device 100, in the form of a reflection 216 of the beam 212. The reflection 216 returns through the window 208 and is captured by the image sensor 204. The positions of the image sensor 204, the emitter 200 and the window 208 relative to one another can be stored as calibration data in the device 100. The calibration data can be used along with a location at which the reflection 216 impacts the image sensor 204 (e.g., pixel coordinates at the image sensor 204) to determine a depth D from the image sensor 204 to the point on the tire 104 at which the reflection 216 originated.

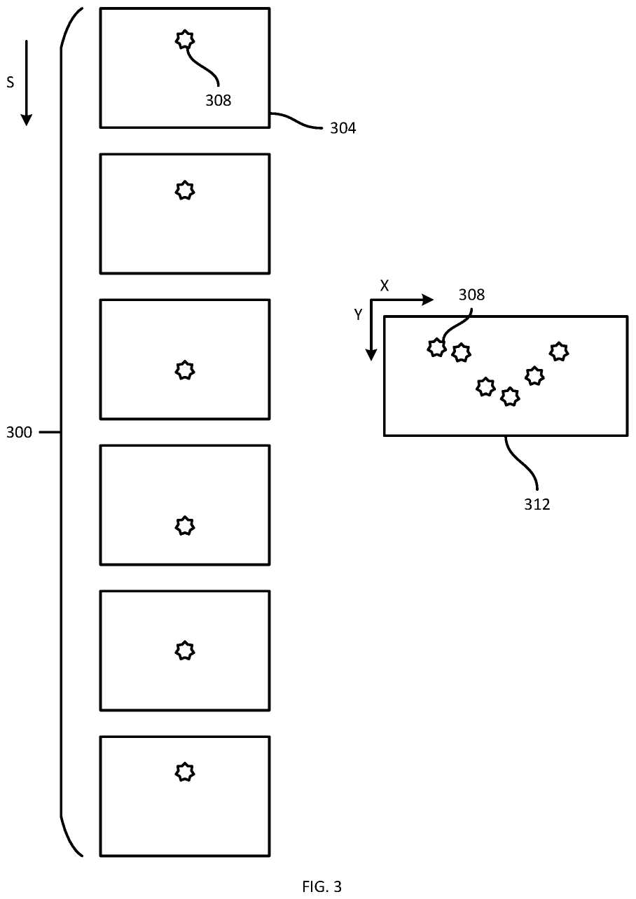

To collect depth measurements as the device 100 traverses the tire 104, the sensor 204 is configured to capture a sequence of representations of the tire 104, such as images of the tire 104, each depicting or otherwise representing a corresponding reflection 216. For example, the representations can include one-dimensional or two-dimensional images with brightness values of one or more pixels indicating the position at which a reflection 216 impacted the sensor 204. In other examples, the representations can include depth measurements, e.g., obtained from an ultrasonic sensor or the like. The position at which the reflection 216 impacts the sensor 204 varies with the distance between the sensor 204 and the treaded surface of the tire 104. Turning to FIG. 3, a sequence 300 of images is illustrated, captured as the device 100 traverses the tire 104 in the scan direction S. Each individual image 304 includes a region 308 corresponding to a reflection 216 (e.g., distinguished by a higher intensity, different color, or the like, than the remainder of the image 304). As the device 100 traverses the tire 104, the positions of successive regions 308 in successive images 304 changes with the tread depth of the tire 104. The device 100 can be configured to combine the reflections 308 from the sequence 300 of images into a tire profile 312. For example, the tire profile 312 can include an image in which the “X” coordinate corresponds to a distance along the scan direction S, and the “Y” coordinate corresponds to a depth. The profile 312 can be provided to another computing device, displayed by the device 100, analyzed to convert the Y positions of the reflections 308 to tread depth measurements, and the like.

Traversing the tire 104 with the device 100 may involve an operator holding the device 100 over the tire 104 and swiping the device 100 across the tire in the scan direction S, while maintaining a substantially constant distance between the device 100 and the tire 104 (e.g., while keeping the device 100 substantially horizontal). Some devices 100 are configured to capture images such as the sequence 300 for a predetermined period of time upon initiation of a scan (e.g., four seconds, although a wide variety of other time periods can also be employed).

However, a fixed-length time period may result in termination of the scan before the device 100 has completely traversed the tire 104. For example, an inexperienced operator and/or a large tire, may require more time than permitted by the fixed scan period to traverse the treaded surface with the device 100. The resulting tire profile 312 may therefore be incomplete. In other scenarios, the fixed-length time period may result in inefficient deployment of the device 100. For example, an experienced operator and/or a small tire may require less than time than dictated by the fixed scan period to traverse the treaded surface with the device 100. The scan may therefore be completed, but the device 100 may not be ready to initiate a further scan until the fixed scan period has elapsed. As discussed below, the device 100 therefore implements certain functionality to adaptively alter the duration of a scan, by detecting either or both of the leading and trailing boundaries 116 and 120 of the tire 104, and determining scan trigger points based on such detections.

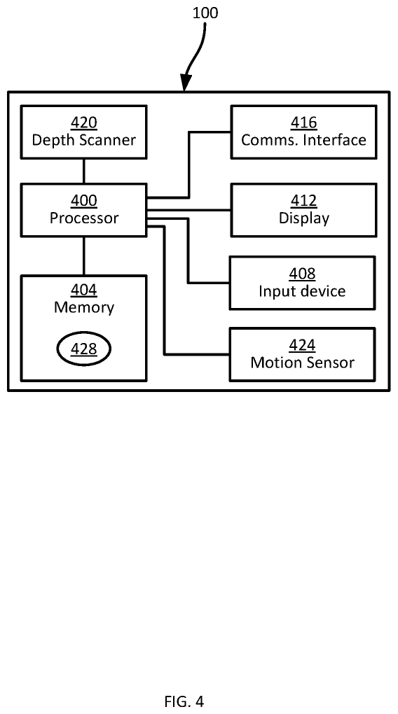

Turning to FIG. 4, certain internal components of the device 100 are illustrated. The device 100 includes a processor 400, such as one or more central processing units (CPUs) or graphics processing units (GPUs), interconnected with a non-transitory computer readable storage medium, such as a memory 404. The memory 404 includes any suitable combination of volatile memory (e.g., Random Access Memory (RAM)) and non-volatile memory (e.g., read only memory (ROM), Electrically Erasable Programmable Read Only Memory (EEPROM), flash memory). The processor 400 and the memory 404 each comprise one or more integrated circuits.

The computing device 100 also includes at least one input device 408 interconnected with the processor 400. The input device 408 is configured to receive input and provide data representative of the received input to the processor 400. The input device 408 can include any one of, or any suitable combination of, a touch screen, a keypad, a trigger button, a microphone, or the like. The computing device 100 also includes a display 412 (e.g., a display panel integrated with the above-mentioned touch screen) interconnected with the processor 400. The computing device 100 can also include one or more output devices in addition to the display 412, such as a speaker, a notification LED, and the like (not shown).

The computing device 100 also includes a communications interface 416 interconnected with the processor 400. The communications interface 416 includes any suitable hardware (e.g., transmitters, receivers, network interface controllers and the like) allowing the computing device 100 to communicate with other computing devices via wired and/or wireless links (e.g., over local or wide-area networks). The specific components of the communications interface 416 are selected based on the type(s) of network(s) or other links that the computing device 100 is required to communicate over.

The computing device 100 also includes a depth scanning assembly 420, also referred to as a depth scanner 420, interconnected with the processor 400. The depth scanning assembly 420, in the present example, includes the emitter 200 and image sensor 204 mentioned in connection with FIG. 2. In other examples, the depth scanning assembly 420 can include additional emitters and/or images sensors, or other depth-sensing components instead of the emitter 200 and image sensor 204. The computing device 100 can also include a motion sensor 424, such as an accelerometer, gyroscope, or a combination thereof (e.g., an inertial measurement unit, IMU).

The memory 404 of the computing device 100 stores computer readable instructions executable by the processor 400. The instructions can be implemented as one or more software applications, and execution of the above-mentioned instructions by the processor 400 causes the computing device 100 to implement certain functionality. In the present example, the memory 404 stores a boundary detection application 428, also referred to herein as the application 428. In other examples, the processor 400, as configured by the execution of the application 428, is implemented as one or more specifically-configured hardware elements, such as field-programmable gate arrays (FPGAs) and/or application-specific integrated circuits (ASICs).

The computing device 100 is configured, via execution of the application 428 by the processor 400, to capture image data as discussed above, and to assess certain attributes of the captured image data to detect boundaries of the object being scanned (e.g., the leading and/or trailing boundaries 116 and 120 of the tire 104). The device 100 is further configured to determine scan trigger points based on the detected boundaries. Scan trigger points can be, for example, initial and/or final samples of image data, with any captured images outside the trigger points being discarded or otherwise marked as not forming part of the resulting profile 312. The device 100 can therefore generate the profile 312 using the determined scan trigger points, and interrupt data capture to place the device 100 in a state ready to initiate a further scan. The dynamic detection of scan trigger points permits the device 100 to perform scans of variable lengths, e.g., to accommodate a range of tire sizes, a range of operator experience levels, and the like.

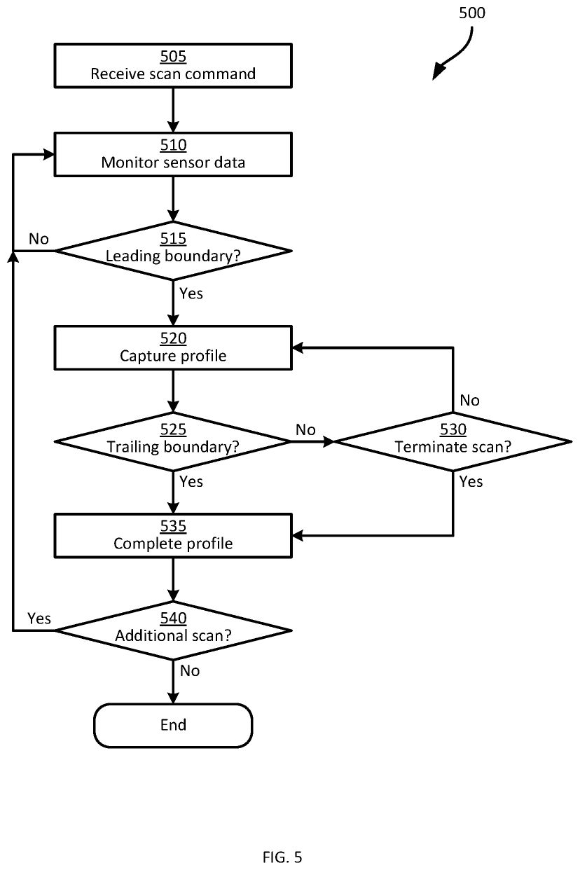

The functionality implemented by the computing device 100 via execution of the application 224 will now be described in greater detail, with reference to FIG. 5. FIG. 5 illustrates a method 500 for adaptive sensor data acquisition. The method 500 will be described in conjunction with its performance by the computing device 100, in particular via the execution of the application 428 by the processor 400. In other examples, certain blocks of the method 500 can be performed by a separate computing device, as noted below.

At block 505, the device 100 receives a scan initiation command, to begin emitting light via the emitter 200 and capturing reflections 216 at the image sensor 204. The scan initiation command can be received at the processor 400 from the input device 408, e.g., in the form of a trigger pull, a selection of a command element via a touch screen, activation of a button, or the like. In other examples, the emitter 200 and image sensor 204 operate continuously, and block 505 can therefore be omitted. In the discussion below however, the scan initiation command is assumed to be an explicit input provided to the processor 400 via the input device 408, and the emitter 200 and image sensor 204 are assumed to be inactive prior to receipt of the initiation command at block 505.

At block 510, the processor 400 is configured, responsive to receiving the initiation command, to activate the emitter 200 and the image sensor 204, and to begin monitoring image data captured by the image sensor 204. In some examples, the processor 400 can also be configured to begin monitoring motion data generated by the motion sensor 424, such as data defining an orientation of the device relative to a gravity vector, and/or acceleration of the device in one or more directions.

As discussed in connection with FIG. 3, the image data received at block 510 includes a sequence of images each indicating a location on the image sensor 204 impacted by a reflection 216. The images can be stored in the memory 404, e.g., temporarily for further processing as discussed below.

At block 515, the processor 400 can be configured to determine whether the device 100 has traversed a leading boundary of the object being scanned, such as the leading boundary 116 of the tire 104. Traversing the leading boundary of an object means that as the device 100 travels along the scan direction, the emitter 200 passes over the leading boundary 116, and thus image data captured at the sensor 204 includes a sequence of images depicting reflections 216 from portions of the tire 104 surrounding and/or at the leading boundary 116. More generally, as will be apparent in the discussion herein, the device 100 traverses a boundary (whether leading or trailing) of an object when the emitter 200 passes over the boundary and the sensor 204 captures images representing reflections 216, from which depth measurements can be derived, originating from the object around and/or at the boundary.

Detecting whether the device 100 has traversed the leading boundary can include, for example, determining whether a position of a reflection indicated in a captured image meets a predetermined threshold. In other examples, the positions of reflections in the captured images can be converted to depth measurements (e.g., based on the calibration data mentioned earlier), and the device 100 can determine whether the depth measurement derived from each image meets a predetermined threshold.

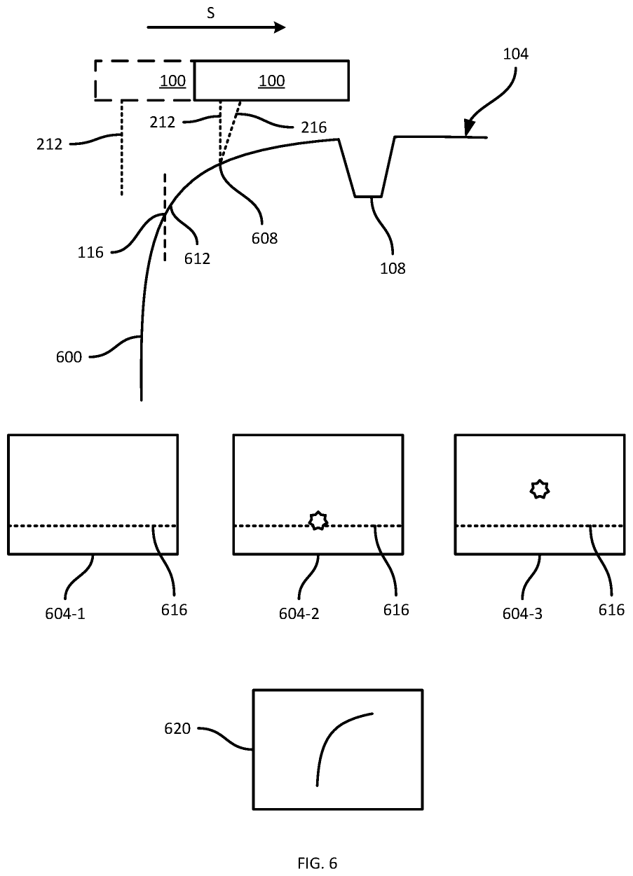

For example, turning to FIG. 6, a portion of the tire 104 is shown, including a sidewall 600 divided from the treaded surface of the tire 104 by the leading boundary 116. As the device 100 moves along the scan direction, a set of images 604-1, 604-2, and 604-3 are captured. The image 604-1 is captured at the position of the device 100 shown in dashed lines. The image 604-3 is captured at the position of the device 100 shown in solid lines, at which the beam 212 impacts the tire 104 at a point 608. The image 604-2 is captured at a position of the device 100 in between the two positions mentioned above, at which the beam 212 impacts the tire 104 at a point 612. In practice, a larger number of images than three may be captured during travel of the device 100 between the positions illustrated in FIG. 6.

In response to capturing each image 604, the processor 400 can compare the position of a reflection in the image, or the depth represented by that position, to a threshold 616. The threshold 616 is shown in FIG. 6 as a position superimposed on the images 604, but can also be defined as a depth measurement rather than an image position. As shown in FIG. 6, some images (e.g., the image 604-1) contain no reflection, because the beam 212 does not impact the sidewall 600 of the tire 104, or impacts the sidewall 600 but does not generate a reflection sufficiently intense to reach the sensor 204. Other images may produce reflections 216 that reach the sensor 204, but correspond to depths greater than the threshold 616. The determination at block 515 in connection with the image 604-2 is affirmative, because the reflection in the image 604-2 indicates a smaller depth than the threshold 616.

In other examples, the determination at block 515 can include comparing a set of successive images, such as the set of images 604, to a predetermined pattern, such as the pattern 620 shown in FIG. 6, to determine whether the reflections shown in the set of images match the pattern 620 (e.g., fit the pattern within a predetermined degree of error, or the like). In other examples, the set of images can be provided as inputs to a classification model trained on labelled sets of images representing leading boundaries of various tires. The model, in other words, represents a predetermined pattern, and can return a classification indicating whether the input set of images corresponds to a leading boundary of the tire 104.

Returning to FIG. 5, when the determination at block 515 is negative, the device 100 can continue monitoring sensor data at block 510. In some examples, the processor 400 can also monitor a timeout period initiated in response to the command from block 505. If no affirmative determination at block 515 is made within the timeout period, the method 500 may be terminated, e.g., and an error notification can be generated on the display 412, via a speaker, or the like. The processor 400 can also monitor data from the motion sensor 424 during the timeout period in some examples, e.g., to determine whether the orientation of the device 100 indicates that the device 100 is positioned for scanning (e.g., positioned horizontally), and/or whether the device 100 is moving substantially linearly (e.g., indicating movement along the scan direction). When the device is idle (e.g., not moving linearly), and/or when the device is not in an active scanning orientation (e.g., substantially horizontal, as shown in FIG. 1), the above error notification can be generated when the timeout period expires.

When the determination at block 515 is affirmative, the device 100 proceeds to block 520. In some examples, block 515 can be omitted, and the scan command from block 505 can lead directly to block 520. In other words, in some examples a trigger pull or other input command can immediately begin a profile capture, rather than initiating monitoring of sensor data for a leading edge of the tire 104.

At block 520, the device 100 is configured to capture a profile (e.g., a profile of the tire 104). Capturing the profile includes storing or otherwise processing images from the sequence of images captured by the sensor 204 to generate a profile. In other words, certain images from the sequence contribute to the profile, while others, such as those captured before the affirmative determination at block 515, do not contribute to the profile. The device 100 is configured, based on the detection of the leading boundary at block 515, to determine a scan trigger point, e.g., such as an initial image in the sequence captured by the sensor 204 that will contribute to the profile. The scan trigger point determined at block 520, in other words, marks the start of a set of images in the full sequence that will contribute to the profile. The other scan trigger point, marking the end of the set, is determined later in the method 500. That is, at block 520, the scan operation has begun, but need not have a defined time period.

At block 525, having begun accumulating image data for profile generation, the processor 400 is configured to detect whether the device 100 has traversed a trailing boundary of the object being scanned, such as the tire 104. The detection of the trailing boundary can include, for example, determining whether a depth of the treaded surface as indicated in an image captured by the sensor 204 is greater than the threshold 616 (rather than being smaller than the threshold 616, as at block 515. The detection of the trailing boundary can also be based on matching a predetermined pattern corresponding to a trailing boundary of a tire 104, as noted above in connection with leading boundary detection at block 515.

When the determination at block 525 is negative, the device 100 can be configured to continue capturing data for the profile. In some examples, the device 100 can determine whether to terminate the scan at block 530, despite not yet having detected a trailing boundary. For example, the device 100 can determine whether motion data from the motion sensor 424 indicates that the device 100 has returned to a non-scanning orientation, has stopped moving linearly, or the like. In some examples, the device 100 can compare the time elapsed since initiating profile capture at block 520 has exceeded a timeout threshold (e.g., a period expected to exceed most or all scans, even those performed on large tires by inexperienced users).

When the determination at block 530 is negative, the device 100 continues capturing data for the profile, and monitoring incoming sensor data for a trailing boundary. When the determination at block 530 is affirmative, or following an affirmative determination at block 525, the device proceeds to block 535.

At block 535, the device 100 is configured to complete capture of the profile initiated at block 520. Completing the profile can include determining, based on the detection at block 525 that the device 100 traversed the trailing boundary 120, a further scan trigger point representing the final sample of image data that contributes to the profile. The device 100 can therefore select the contiguous set of images between the initial and final scan trigger points, and generate a profile (e.g., of the treaded surface of the tire 104) based on the selected images.

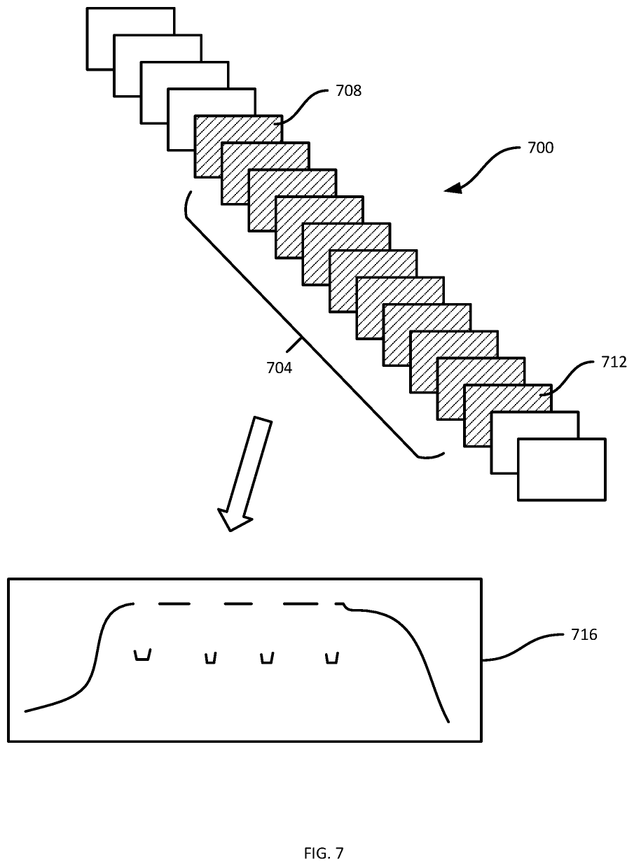

Turning to FIG. 7, a sequence 700 of images is illustrated. A set 704 of images is selected from the sequence 700 according to a first scan trigger point 708 and a second scan trigger point 712. As will be apparent, the first scan trigger point 708 is an image for which an affirmative determination was made at block 515, and the second scan trigger point 712 is an image for which an affirmative determination was made at block 525. The set 704 of images is used to generate a profile 716, e.g., as discussed in connection with FIG. 3. The images outside the set 704 can be discarded.

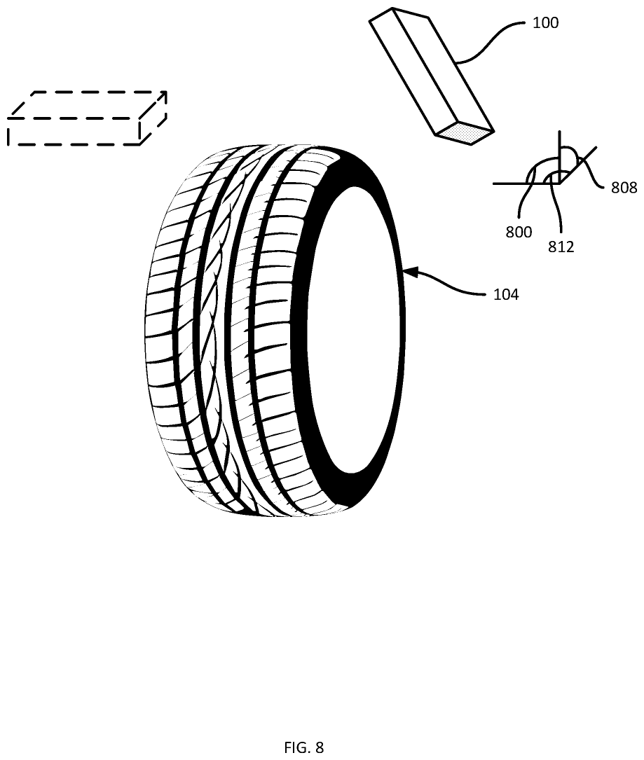

As noted above, the device 100 can also complete the profile at block 535 in response to an affirmative determination at block 530, without detecting a trailing boundary of the tire 104. For example, turning to FIG. 8, the device 100 may be lifted from the scanning orientation shown in dashed lines (e.g., substantially horizontal) towards a portrait orientation shown in solid lines, before the trailing boundary 120 is detected in the image data captured by the sensor 204. In response to detecting that an angle of orientation of the device 100 deviates from the scanning orientation by more than a threshold (e.g., ten degrees, although a wide variety of other thresholds can also be employed), the determination at block 530 may be affirmative. The angle of orientation assessed at block 530 can include any combination of a pitch angle 800, a yaw angle 804, and a roll angle 808.

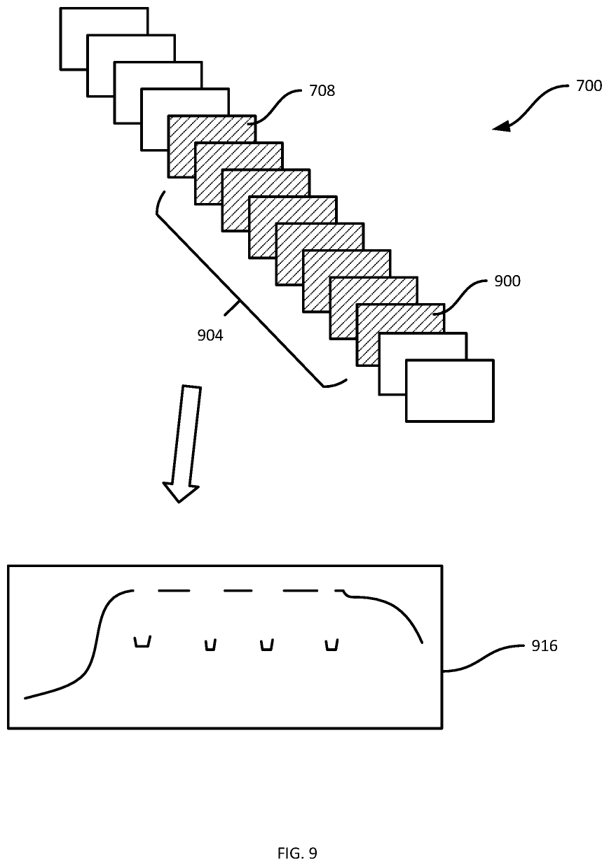

Turning to FIG. 9, in response to the affirmative determination at block 530, the device 100 may, at block 535, complete the profile by determining a second trigger point 900 within the sequence 700, and generate a profile 916 based on the images between the first scan trigger point 708 and the second scan trigger point 900. The profile 916, as seen by comparison with the profile 716 shown in FIG. 7, is cut off earlier and may not depict the trailing boundary 120 of the tire 104. The profile 916 may still be usable, however. When the device 100 generates a profile following an affirmative determination at block 530, the device 100 can generate a notification (e.g., an audible beep, a warning on the display 412, or the like) indicating that the profile may have been completed prematurely.

Returning to FIG. 5, at block 540 the device 100 can be configured to determine whether to initiate another scan. For example, the ability of the device 100 to dynamically determine scan trigger points permits the device to generate sequential profiles for sets of tires 104, e.g., mounted on tractor trailers, aircraft, or other systems with multiple banks of adjacent tires 104. The device 100 can, for example, be operated in a single-scan mode or a multi-scan mode, and the determination at block 540 can include determining whether the multi-scan mode is active. When the determination at block 540 is affirmative, the device 100 can return to block 510 and begin monitoring image and, optionally, motion data for a further leading boundary (e.g., of another tire 104). When the determination at block 540 is negative, the device 100 can terminate the performance of the method 500, e.g., by disabling the image sensor 204 and the motion sensor 424.

In some examples, certain processing described above as being performed by the device 100 can be performed by a host computing device, such as a tablet computer or the like communicatively coupled with the device 100 (e.g., via a short-range connection such as a Bluetooth™ connection). For example, the device 100 can be configured to transmit image and motion data to the host computing device, substantially in real time. The host computing device can then be configured to perform the determinations at one or more of blocks 515, 525, and 530, and return commands to the device 100 indicating the outcome of such determinations.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
monitoring sensor data including one or more representations of a treaded surface captured by a device;
detecting, based on the sensor data, that the device has traversed a boundary of the treaded surface;
in response to detecting that the device has traversed the boundary, determining a scan trigger point within the one or more representations; and
generating a profile of the treaded surface from the one or more representations based on the scan trigger point.

2. The method of claim 1, wherein detecting that the device has traversed the boundary includes comparing a depth derived from a representation to a threshold depth.

3. The method of claim 1, wherein detecting that the device has traversed the boundary includes:
comparing a set of successive representations to a predetermined pattern; and
determining that the set of representations matches the predetermined pattern.

4. The method of claim 1, wherein the sensor data further includes motion data, and wherein detecting that the device has traversed the boundary includes determining, based on the motion data, that an orientation of the device matches a predetermined scan orientation.

5. The method of claim 1, wherein the boundary of the treaded surface is a leading boundary, and wherein the determined scan trigger point corresponds to a start of the profile.

6. The method of claim 1, wherein the boundary of the treaded surface is a trailing boundary, and wherein the determined scan trigger point corresponds to an end of the profile.

7. The method of claim 6, further comprising:
prior to the detecting, receiving a scan command at an input of the device, wherein the capture command corresponds to a beginning of the profile.

8. The method of claim 7, further comprising: in response to generating the profile, terminating monitoring of the sensor data.

9. The method of claim 7, further comprising: in response to generating the profile, monitoring the sensor data to detect, based on the sensor data, that the device has traversed a further boundary of a further treaded surface.

10. The method of claim 1, wherein the sensor data is captured by a sensor, and wherein the one or more representations depict reflections of a beam of light emitted by a device configured to traverse a treaded surface.

11. The method of claim 1, wherein the one or more representations of the treaded surface includes one or more images of the treaded surface.

12. A computing device, comprising:
an emitter;
a sensor; and
a processor configured to:
monitor sensor data including one or more representations of a treaded surface captured by the sensor;
detect, based on the sensor data, that the device has traversed a boundary of the treaded surface;
in response to detecting that the device has traversed the boundary, determine a scan trigger point within the one or more representations; and
generate a profile of the treaded surface from the one or more representations based on the scan trigger point.

13. The computing device of claim 12, wherein the processor is configured to detect that the device has traversed the boundary by comparing a depth derived from an representation to a threshold depth.

14. The computing device of claim 12, wherein the processor is configured to detect that the device has traversed the boundary by:
comparing a set of successive representations to a predetermined pattern; and
determining that the set of representations matches the predetermined pattern.

15. The computing device of claim 12, wherein the sensor data further includes motion data, and wherein the processor is configured to detect that the device has traversed the boundary by determining, based on the motion data, that an orientation of the device matches a predetermined scan orientation.

16. The computing device of claim 12, wherein the boundary of the treaded surface is a leading boundary, and wherein the determined scan trigger point corresponds to a start of the profile.

17. The computing device of claim 12, wherein the boundary of the treaded surface is a trailing boundary, and wherein the determined scan trigger point corresponds to an end of the profile.

18. The computing device of claim 17, wherein the processor is further configured to:
prior to the detecting, receiving a scan command at an input of the device, wherein the capture command corresponds to a beginning of the profile.

19. The computing device of claim 18, wherein the processor is further configured to:
in response to generating the profile, terminating monitoring of the sensor data.

20. The computing device of claim 18, wherein the processor is configured to:
in response to generating the profile, monitoring the sensor data to detect, based on the sensor data, that the device has traversed a further boundary of a further treaded surface.

21. The computing device of claim 12, wherein the one or more representations depict reflections of a beam of light emitted by a device configured to traverse a treaded surface.

22. The computing device of claim 12, wherein the one or more representations of the treaded surface includes one or more images of the treaded surface.
